(19) United States
(12) Patent Application Publication
(10) Pub. No.: US 2023/0316169 A1
(43) Pub. Date: Oct. 5, 2023

(54) SYSTEM AND METHOD FOR OPTIMIZATION OF RESOURCE ROUTING IN A NETWORK BASED QUANTUM COMPUTING

(71) Applicant: BANK OF AMERICA CORPORATION, Charlotte, NC (US)

(72) Inventors: George Anthony Albero, Charlotte, NC (US); Jinna Zevulun Kim, Charlotte, NC (US); Maharaj Mukherjee, Poughkeepsie, NY (US); Jake Michael Yara, Mint Hill, NC (US)

(73) Assignee: BANK OF AMERICA CORPORATION, Charlotte, NC (US)

(21) Appl. No.: 17/709,043

(22) Filed: Mar. 30, 2022

(51) Int. Cl. G06Q 10/06; G06N 10/60

(52) U.S. Cl. CPC G06Q 10/0631; G06N 10/60

(57) ABSTRACT

Embodiments of the present invention include apparatuses (e.g., a system, computer program product and/or other devices) and methods for providing optimization of resource routing using quantum computing. The invention employs the use of quantum computing to analyze a number of data dreams in real-time, or near-real-time, in order to provide recommendations for replenishment of resource distribution devices, or recommendations for routing of resource distribution vehicles to devices in a specific geographic area.

### FIELD OF THE INVENTION

The present invention embraces a system for resource routing using quantum optimization.

### BACKGROUND

In certain instances, entities are able to plan for high demand situations which will require additional or more frequent replenishing of resources at resource distribution devices. However, current methods depend on a classical computing platform for optimization, which is often slow and may not be able to adjust to changing circumstances or increased need in certain areas. As such, current systems would benefit from the use of a quantum computing enabled optimization platform for more efficient distribution and planning of resource replenishments.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing optimization of resource routing in a network based quantum computing architecture. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention generally includes the steps of: routing a resource distribution vehicle to a first resource distribution device; continuously monitoring a real-time location of the resource distribution vehicle; identifying that the real-time location of the resource distribution vehicle is within a predetermined distance from one or more additional resource distribution devices; continuously monitoring and analyze one or more data streams via a quantum computing system to determine an event status; based on the event status, determining a subset of the one or more additional resource distribution devices which require resource replenishment; identifying an owner for each of the subset of the one or more additional resource distribution devices; generating a network communication, wherein the communication comprises a recommendation for replenishment of resources at the subset of the one or more additional resource distribution devices and transmit the communication to the identified owners; and receiving a responsive acceptance or denial of the recommendation.

In some embodiments, the invention is further configured to forward the responsive acceptance or denial of the recommendation to the resource distribution vehicle.

In other embodiments, the event status further comprises an increased need for resource in the location of the resource distribution vehicle.

In still further embodiments, determining a subset of the one or more additional resource distribution devices which require resource replenishment further comprises determining that the subset is owned by one or more institutions which are members of an affiliate network.

In some embodiments, the real-time location of the resource distribution vehicle is determined by receiving global positioning system data from the resource distribution vehicle.

In other embodiments, determining a subset of the one or more additional resource distribution devices which require resource replenishment further comprises applying one or more rules defined by an affiliate network.

In further embodiments, the one or more rules define a priority for the one or more additional resource distribution devices.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for quantum optimization of resource routing, in accordance with an embodiment of the invention;

FIG. 2 provides a block diagram illustrating the entity system 200 of FIG. 1, in accordance with an embodiment of the invention;

FIG. 3 provides a block diagram illustrating a quantum computing system 150 of FIG. 1, in accordance with an embodiment of the invention;

FIG. 4 provides a block diagram illustrating a resource distribution device 400 of FIG. 1, in accordance with an embodiment of the present invention;

FIG. 5 provides a block diagram for a plurality of computing systems 500 of FIG. 1, in accordance with an embodiment of the present invention; and

FIG. 6 provides a flowchart illustrating a process flow for resource routing optimization, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, the term “entity” or “resource entity” may be any institution which involves in distribution of resources such as financial transactions. In one embodiment, the term “entity” or “resource entity” may be any financial institution. As used herein, the term “resource distribution device” described herein may be any devices or financial instruments that are involved in distribution of resources such as cash, checks, electronic transfers, goods, services, vouchers, money orders or the like which may be performed using a resource distribution card (e.g., credit card, debit card, membership card, or the like). In some embodiments, the resource distribution device may be owned or maintained by a financial entity. In some embodiments, the resource distribution devices may be owned or maintained by a third party entity. In some embodiments of the present invention, the resource distribution device may be an Automated Teller Machine (ATM). In some embodiments of the present invention, the resource distribution device may be a POS device at a third party entity location.

As used herein, the term “third party entity” may be any merchant who is a customer of the entity. In some embodiments, the resource entity may be a customer of the third party entity. For example, the third party entity may be a vault management entity which delivers resources form the vault to multiple resource distribution services and collects money from multiple resource distribution devices and other third party entity locations to deliver it back to the vault. As used herein, the term “resource delivery vehicle” may be any armored truck which is maintained by a third party entity. In some embodiment, the resource delivery vehicle may be maintained by the resource entity directly. As described herein, the term “user” may be an employee of the entity.

Typically, the process of distribution of resources involves a user of the resource shutting down a resource distribution device for loading resources, picking up resources, processing of resources, and settlement of resources. This causes inconvenience to the customers of the entity and also decreases the efficiency of distribution of resources. Therefore, there exists a need for a system to optimize the distribution of resources to avoid downtime of the resource distribution devices. The system of the present invention allows for the optimization of resource routing to various locations via the use of quantum optimization, thereby reducing the down-time of resource distribution devices.

As used herein, a “quantum computer” is any computer that utilizes the principles of quantum physics to perform computational operations. Several variations of quantum computer design are known, including photonic quantum computing, superconducting quantum computing, nuclear magnetic resonance quantum computing, and/or ion-trap quantum computing. Regardless of the particular type of quantum computer implementation, all quantum computers encode data onto qubits. Whereas classical computers encode bits into ones and zeros, quantum computers encode data by placing a qubit into one of two identifiable quantum states. Unlike conventional bits, however, qubits exhibit quantum behavior, allowing the quantum computer to process a vast number of calculations simultaneously. A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously. In a quantum computer with n qubits, the quantum computer can be in a superposition of up to 2n states simultaneously. By comparison, a classical computer can only be in one of the 2n states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three qubit system can store the information of eight classical bits, four qubits can store the information of sixteen classical bits, and so on. A quantum computer with three hundred qubits could possess the processing power equivalent to the number of atoms in the known universe.

Data packets are basic units of communication over a digital network. A data packet may also be referred to as a datagram, a segment, a block, a cell or a frame, depending on the protocol used for the transmission of data. When data has to be transmitted, it is typically broken down into similar structures of data before transmission, called data packets, which are reassembled to the original data chunk once they reach their destination. When one or more of these packets is interrupted in its journey, this is known as packet loss. Packet loss may occur due to a number of reasons, such as network hardware issues, software bugs, capacity overload, or the like, but most often packet loss occurs due to network congestion. Transmission protocols, such as Internet Protocol (IP), allows for routers to simply drop packets if a node or a network segment is too busy to deliver the data in the timely fashion. Typically, network nodes often devote a significant amount of storage space (buffers) for data packets while they wait to verify that the next node has properly received them. During peak network traffic, these buffers may be overloaded, causing dropped packets. With increasing number of users consuming streaming services these days, often these data packets are time-sensitive, and dropped packets cause disruption in service or loss in quality of the service are major issues. In most packet-switching networks, each node is provided with the ability to make its own decision locally, as to which packets are forwarded and which ones are dropped based on its buffer capacity and use. However, there is a lack of global perspective when such decisions are allowed to be made at the node-level. Therefore, there is a need for a system for packet cluster routing using quantum optimization within a distributed network.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally speaking, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present invention make use of quantum ability of optimization by utilizing a quantum computer in conjunction with a classical computer. Such a configuration enables the present invention to take advantage of quantum speedup in solving optimization problems, while avoiding the drawbacks and difficulty of implementing quantum computing to perform non-optimization calculations. Examples of quantum computers that can be used to solve optimization problems parallel to a classic system are described in, for example, U.S. Pat. Nos. 9,400,499, 9,207,672, each of which is incorporated herein by reference in its entirety.

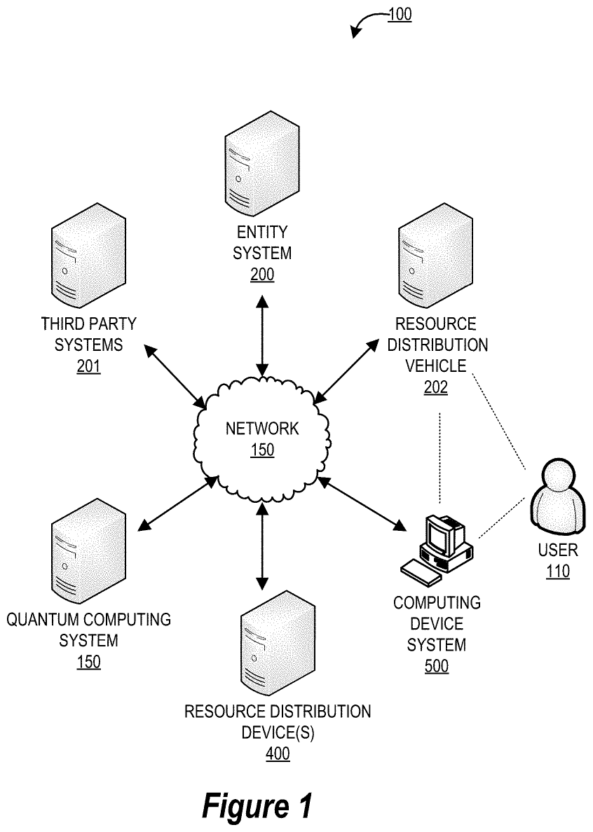

FIG. 1 provides a block diagram illustrating a system environment 100 for quantum optimization of resource routing. As illustrated in FIG. 1, the environment 100 includes a quantum computing system 150, resource distribution devices 400, entity system 200, one or more third party systems 201, and one or more resource distribution vehicles 202. In some embodiments, the resource distribution devices 400 may be operated, maintained, and/or controlled by the quantum computing system 150. In some embodiments, the resource distribution devices 400 may be operated, maintained, and/or controlled by the entity systems 200. In some embodiments, the resource distribution devices 400 may be operated, maintained, and/or controlled by both the quantum computing system 150 and the entity system 200. In some embodiments, the one or more resource distribution vehicles 202 may be operated, maintained, and/or controlled by the third party entity systems 201. In some other embodiments, the one or more resource distribution vehicles 202 may be operated, maintained, and/or controlled by the entity system 200. One or more users 110 may be included in the system environment 100, where the users 110 interact with the other entities of the system environment 100 via a user interface of the resource distribution device 400. The one or more users 110 may be any user in the resource distribution vehicle 202. For example, the user 100 may be a driver of the resource distribution vehicle 202.

In some embodiments, the quantum computing system 150 may be a part of the entity system. In such an embodiment, the quantum computing system 150 may transmit control signals remotely to the resource distribution device 400 to perform one or more actions and the computing devices described herein. In some embodiments, the quantum computing system 150 may be a remote and independent system which interacts with other systems in the system environment to perform one or more steps described herein. In such an embodiment, the system remotely communicates and/or manages the resource distribution vehicle 202, resource distribution devices 400, and/or computing device systems 400. In some embodiments, the quantum computing system 150 may be a part of the resource delivery vehicle 202, the resource distribution device 400, or the computing device system.

The entity system(s) 200 may be any system owned or otherwise controlled by an entity to support or perform one or more process steps described herein. The entity may be any entity which is involved in financial transactions. In some embodiments, the entity is a financial institution. The quantum computing system 150 and the resource distribution device 400 communicate with entity system 200 to perform one or more steps described herein.

The quantum computing system 150, the entity system 200, the resource distribution device 400, the third party system 201, the computing device system 400, and/or the resource distribution vehicle 202 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

In some embodiments, a quantum optimization engine may be core elements of an application, or part of an application that serves as a foundation for a larger piece of software and drives the functionality of the software in the quantum computing system 150. In accordance with the present systems and methods, a quantum computing system 150 may be adapted for integration into the system. The quantum computing system 150 may be configured for continuous operation, or it may be configured to be called upon/activated only when necessary to solve a specific problem (e.g., an optimization problem) that the quantum computing system 150 is particularly well-suited to solve. The quantum computing system 150 may, for example, be configured as a disposable, single-shot system (i.e., a system having a short lifespan or active time) for performing a single or small number of computations (if identified as necessary by the system) that govern a behavior of the system. Configuring the quantum computing system 150 as a disposable, single-shot system has the advantage of relaxing a number of design specifications that are otherwise necessary to provide the continuous, long-term operation typically expected in the known quantum computing arts. In accordance with the present systems and methods, the quantum computing system 150 may be configured to receive data from the system and perform a quantum computing operation (e.g., using the quantum optimization engine) in real-time.

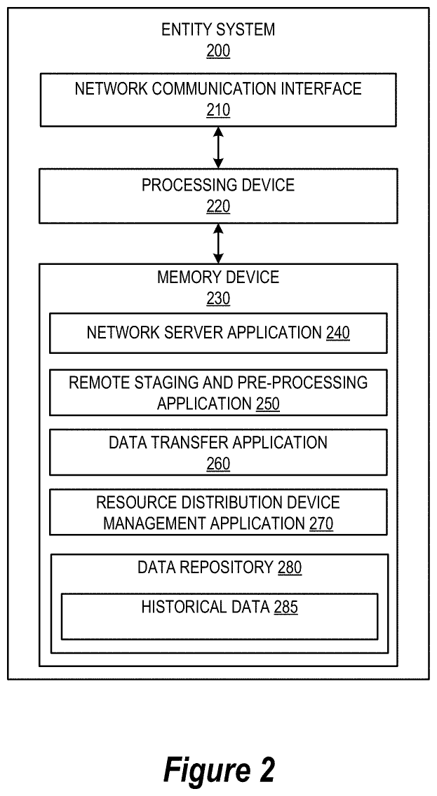

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a remote staging and pre-processing application 250, a data transfer application 260, a resource distribution device management application 270, and a data repository 280 comprising historical data 285. The historical data 285 may be any transactions related historical data. The computer-executable program code of the network server application 240, the remote staging and pre-processing application 250, the data transfer application 260, the resource distribution device management application 270 may instruct the processing device 220 to perform certain logic, data-extraction, and data-storing functions of the entity system 200 described herein, as well as communication functions of the entity system 200.

The network server application 240, the remote staging and pre-processing application 250, the data transfer application 260, the resource distribution device management application 270 are configured to store data in the data repository 280 or to use the data stored in the data repository 280 when communicating through the network communication interface 210 with the quantum computing system 150, the resource distribution device 400, and the resource distribution vehicle 202 to perform one or more process steps described herein. In some embodiments, the entity system 200 may receive instructions from the quantum computing system 150 via the remote staging and pre-processing application 250 to perform certain data transfer operations to the resource distribution vehicle 202 and/or the resource distribution device 400. Upon receiving the instructions from the quantum computing system 150, the entity system 200 transfers data via the data transfer application 260.

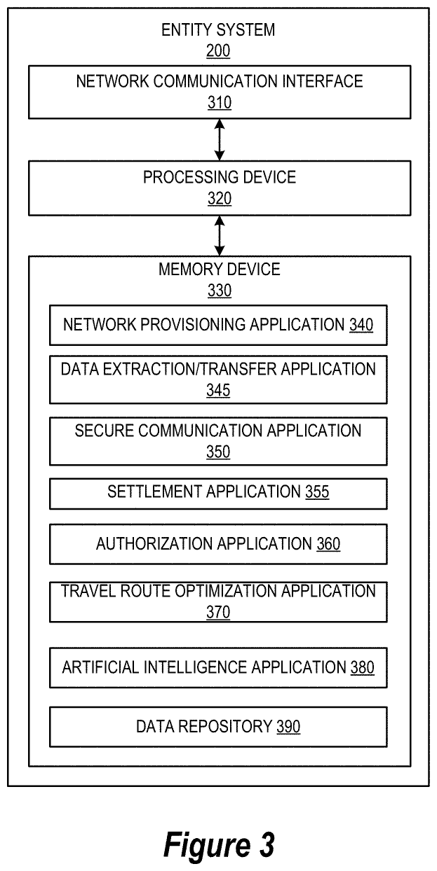

FIG. 3 provides a block diagram illustrating the entity system 200 in greater detail, in accordance with embodiments of the invention. As mentioned above, entity system 200 of FIG. 1 is configured to perform the one or more functions described herein.

As illustrated in FIG. 3, in one embodiment of the invention, the entity system 200 includes one or more processing devices 320 operatively coupled to a network communication interface 310 and a memory device 330. In certain embodiments, the entity system 200 is operated by a first entity, such as a financial institution, while in other embodiments, the entity system 200 is operated by an entity other than a financial institution. In some embodiments, the entity system 200 may be an independent system. In alternate embodiments, the entity system 200 may be a part of the resource distribution device 400, and may act in concert with the quantum computing system 150.

It should be understood that the memory device 330 may include one or more databases or other data structures/repositories. The memory device 330 also includes computer-executable program code that instructs the processing device 320 to operate the network communication interface 310 to perform certain communication functions of the entity system 200 described herein. For example, in one embodiment of the entity system 200, the memory device 330 includes, but is not limited to, a network provisioning application 340, a data extraction/transfer application 345, a secure communication application 350, a settlement application 355, an authorization application 360, a travel route optimization application 370, an artificial intelligence application 380, and a data repository 390. The computer-executable program code of the network provisioning application 340, the data extraction/transfer application 345, the secure communication application 350, the settlement application 355, the authorization application 360, the travel route optimization application 370, and the artificial intelligence application 380, may instruct the processing device 320 to perform certain logic, data-processing, and data-storing functions of the entity system 200 described herein, as well as communication functions of the entity system 200.

In some embodiments, the network provisioning application 340, the data extraction/transfer application 345, the secure communication application 350, the settlement application 355, the authorization application 360, the travel route optimization application 370, and the artificial intelligence application 380 may be a part of single application. The network provisioning application 340 may allow the entity system 200 to communicate with the resource distribution device 400, resource delivery vehicle 202, entity system 200, and other third party entity systems 201 to authorize resource distribution events and also to perform remote staging, pre-processing, and settlement of resource distribution devices 400. The data extraction/transfer application 345 may extract data from data repository 280 of entity system and may use the historical data 285 to intelligently route the resource distribution vehicles 202 via the artificial intelligence application 380. The settlement application 355 allows the entity system 200 to establish a secure communication channel with the resource distribution devices 400, resource delivery vehicle 202, and/or the computing device systems 500. The settlement application 355 facilitates the settlement of the resource distribution devices 400. The authorization application 360 allows the user 110 to gain access to the user computing device system 500, the resource distribution device 300, and/or the resource distribution vehicle 202. The travel route optimization application 370 optimizes the travel route of the resource distribution vehicles 202 based on the historical data and by communicating with the quantum computing system 150 and other third party entity systems 201 in order to improve the efficiency of the resource delivery process.

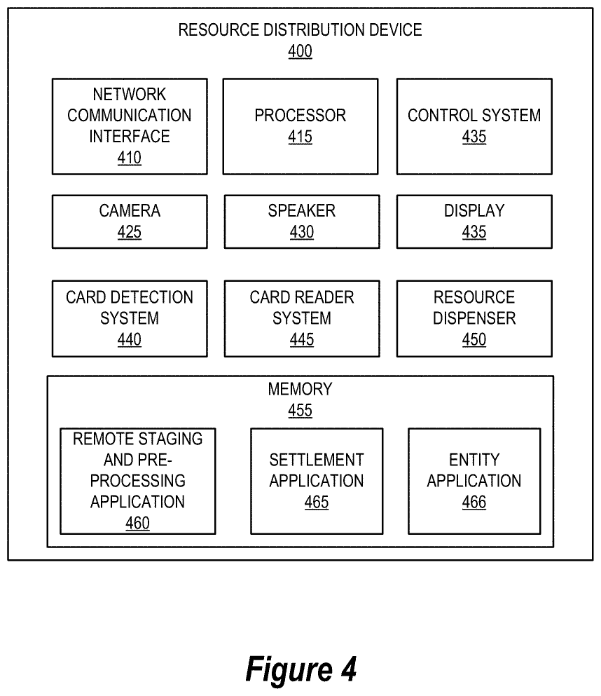

FIG. 4 provides a block diagram of the resource distribution device 400, in accordance with an embodiment of the present invention. As illustrated in FIG. 4, in one embodiment of the invention, the resource distribution device 400 includes a processor 415 operatively coupled to a network communication interface 410, a memory component 455, a control system 435, a camera 425, a speaker 430, a display 435, a card detection system 440, a card reader system 445, and a resource dispenser 450. The resource distribution device may include other components such as bar code scanner, resource counter, to perform multiple functions of the resource distribution devices 400.

It should be understood that the memory component 455 may include one or more databases or other data structures/repositories. The memory component 455 also includes computer-executable program code that instructs the processor 415 to operate the network communication interface 410 to perform certain communication functions of the resource distribution device 400 described herein and also instructs the processor 415 to cause the control system 435 to perform certain actions of the resource distribution device 400 including, but not limited to, dispensing resources, displaying messages on the display 435, performing resource count, or the like. In one embodiment, the memory component may include a remote staging and pre-processing application 460 provided by the quantum computing system 150, an entity application 466 provided by the entity system 200, and a settlement application 465. In some embodiments, the memory component 455 may include only the remote staging and pre-processing application 460 which may allow the resource distribution device 400 to communicate with the entity system 200. Based on the instructions and control signals received from the quantum computing system 150 via network communication interface and the remote staging and pre-processing application 460, the processor 415 via the control system 435 may operate the resource distribution device 400 such as displaying messages on the display 435, completing settlement process, or to perform certain other actions described herein.

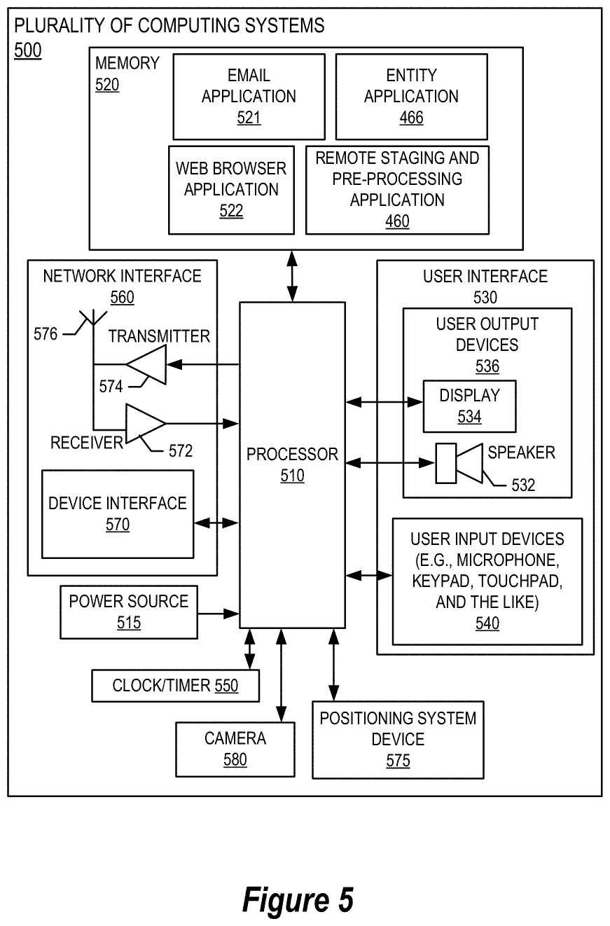

FIG. 5 provides a block diagram illustrating a plurality of computing systems 500 of FIG. 1 in more detail, in accordance with embodiments of the invention. The plurality of computing systems 500 are associated with the plurality of users 110. In one embodiment the plurality of users 110 may be an employee, contractor, or otherwise affiliated with the entity of the plurality of entity systems 200. However, it should be understood that a mobile telephone is merely illustrative of one type of plurality of computing systems 500 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the plurality of computing systems 500 include a processor 510 communicably coupled to such devices as a memory 420, user output devices 536, user input devices 540, a network interface 560, a power source 515, a clock or other timer 550, a camera 580, and a positioning system device 575. The processor 510, and other processors described herein, generally include circuitry for implementing communication and/or logic functions of the plurality of computing systems 500. For example, the processor 510 may include a digital signal processor device, a microprocessor device, and various analog to digital converters, digital to analog converters, and/or other support circuits. Control and signal processing functions of the plurality of computing systems 500 are allocated between these devices according to their respective capabilities. The processor 510 thus may also include the functionality to encode and interleave messages and data prior to modulation and transmission. The processor 510 can additionally include an internal data modem. Further, the processor 510 may include functionality to operate one or more software programs, which may be stored in the memory 520. For example, the processor 510 may be capable of operating a connectivity program, such as a web browser application 522. The web browser application 522 may then allow the plurality of computing systems 500 to transmit and receive web content, such as, for example, location-based content and/or other web page content, according to a Wireless Application Protocol (WAP), Hypertext Transfer Protocol (HTTP), and/or the like.

The processor 510 is configured to use the network interface 560 to communicate with one or more other devices on the network 150. In this regard, the network interface 560 includes an antenna 576 operatively coupled to a transmitter 574 and a receiver 572 (together a “transceiver”). The processor 510 is configured to provide signals to and receive signals from the transmitter 574 and receiver 572, respectively. The signals may include signaling information in accordance with the air interface standard of the applicable cellular system of the network 150. In this regard, the plurality of computing systems 500 may be configured to operate with one or more air interface standards, communication protocols, modulation types, and access types. By way of illustration, the plurality of computing systems 500 may be configured to operate in accordance with any of a number of first, second, third, and/or fourth-generation communication protocols and/or the like. For example, the plurality of computing systems 500 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The plurality of computing systems 500 may also be configured to operate in accordance with non-cellular communication mechanisms, such as via a wireless local area network (WLAN) or other communication/data networks.

As described above, the plurality of computing systems 500 has a user interface that is, like other user interfaces described herein, made up of user output devices 536 and/or user input devices 540. The user output devices 536 include a display 530 (e.g., a liquid crystal display or the like) and a speaker 532 or other audio device, which are operatively coupled to the processor 510.

The user input devices 540, which allow the plurality of computing systems 500 to receive data from a plurality of users 110, may include any of a number of devices allowing the plurality of computing systems 500 to receive data from the plurality of users 110, such as a keypad, keyboard, touch-screen, touchpad, microphone, mouse, joystick, other pointer device, button, soft key, and/or other input device(s). The user interface may also include a camera 580, such as a digital camera.

The plurality of computing systems 500 may also include a positioning system device 575 that is configured to be used by a positioning system to determine a location of the plurality of computing systems 500. For example, the positioning system device 575 may include a GPS transceiver. In some embodiments, the positioning system device 575 is at least partially made up of the antenna 576, transmitter 574, and receiver 572 described above. For example, in one embodiment, triangulation of cellular signals may be used to identify the approximate or exact geographical location of the plurality of computing systems 500. In other embodiments, the positioning system device 575 includes a proximity sensor or transmitter, such as an RFID tag, that can sense or be sensed by devices known to be located proximate a merchant or other location to determine that the plurality of computing systems 500 is located proximate these known devices.

The plurality of computing systems 500 further includes a power source 515, such as a battery, for powering various circuits and other devices that are used to operate the plurality of computing systems 500. Embodiments of the plurality of computing systems 500 may also include a clock or other timer 550 configured to determine and, in some cases, communicate actual or relative time to the processor 510 or one or more other devices.

The plurality of computing systems 500 also includes a memory 520 operatively coupled to the processor 510. As used herein, memory includes any computer readable medium (as defined herein below) configured to store data, code, or other information. The memory 520 may include volatile memory, such as volatile Random Access Memory (RAM) including a cache area for the temporary storage of data. The memory 520 may also include non-volatile memory, which can be embedded and/or may be removable. The non-volatile memory can additionally or alternatively include an electrically erasable programmable read-only memory (EEPROM), flash memory or the like.

The memory 520 can store any of a number of applications which comprise computer-executable instructions/code executed by the processor 510 to implement the functions of the plurality of computing systems 500 and/or one or more of the process/method steps described herein. For example, the memory 520 may include such applications as a conventional web browser application 522, an email application 521, an entity application 466, a remote staging and pre-processing application 460, or the like. The email application 521, the web browser application 522, the remote staging and pre-processing application 460 may allow the plurality of users 110 to communicate with the plurality of entity systems 500, the quantum computing system 150, resource distribution devices 500, resource distribution vehicle 202, and the third party server 201. The entity application 466 allows the one or more users 110 to interact with the plurality of entity systems 200. The remote staging and pre-processing application 460 may be present in the memory 520 of the plurality of computing systems 500 to allow direct communication with the quantum computing system 150 and also the resource distribution devices 500.

The memory 520 can also store any of a number of pieces of information, and data, used by the plurality of computing systems 500 and the applications and devices that make up the plurality of computing systems 500 or are in communication with the plurality of computing systems 500 to implement the functions of the plurality of computing systems 500 and/or the other systems described herein.

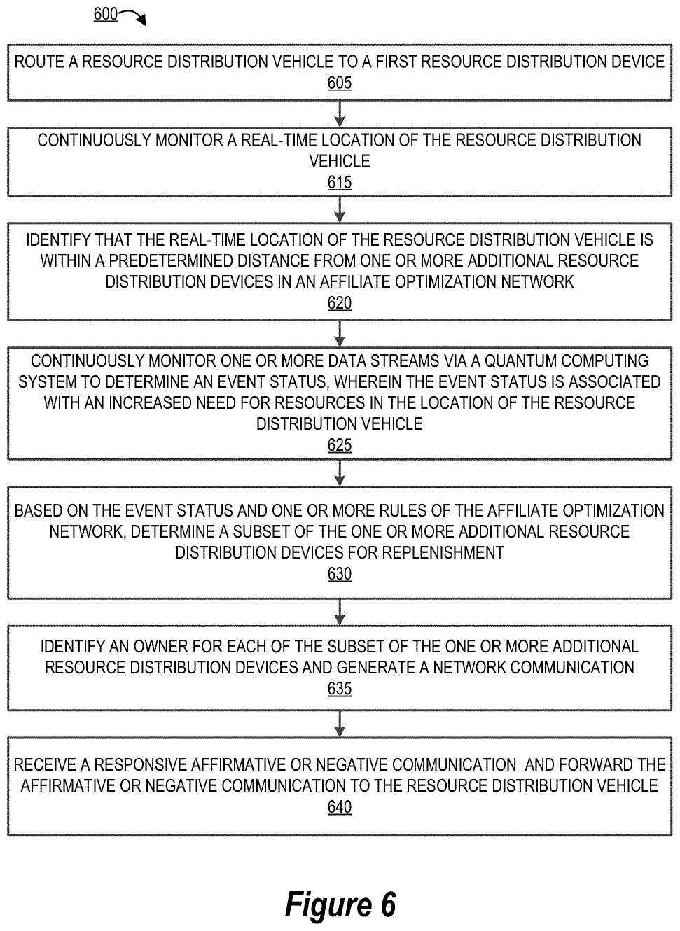

FIG. 6 provides a flowchart illustrating a process flow for resource routing optimization, in accordance with an embodiment of the invention. As shown in the block 605, the system routes a resource distribution vehicle to a first resource distribution device. The system may perform routing of the resource distribution vehicle based on one or more of historical transaction data associated with the resource distribution devices, current resource capacity, traffic conditions, or the like. In one embodiment, the system may determine that the first resource distribution currently has a low resource capacity and may route the resource distribution vehicle to the first resource distribution device. For example, the system may identify that a first ATM is running low on cash and may route the cash delivery truck to the first ATM. In another embodiment, the system may determine that the first resource distribution device is scheduled to receive resources on a specific day, identify that the user traffic is low during a time period on that day based on the historical transaction data of the first resource distribution device, and route the resource distribution vehicle to the first resource distribution device during that time period. For example, the system may identify that a first ATM is scheduled to received cash on a Wednesday and may identify that the first ATM has less user traffic between 3 PM and 4 PM and may route the cash delivery vehicle to the first ATM to perform the cash delivery at 3 PM. In some embodiments, the system may identify that the traffic along the travel route to the first resource distribution device is high between 8 AM and 10 AM and may route the resource distribution vehicle to the first resource distribution device after 10AM.

In other embodiments, the system may determine that user traffic is likely to be high, or need for resources is forecasted to be higher than normal for a particular geographic location where the first resource distribution device is located. For instance, the system may determine that a natural disaster has occurred, a widespread power outage has occurred, an emergency has occurred, a popular event is scheduled to take place, or some other event which would cause an increased demand or need for physical resources in the geographic location. In this instance, the system may determine that it would be optimal for the first resource distribution device to be replenished outside of the normal schedule, or more frequently than it is normally replenished. In some embodiments, as discussed later, optimal replenishment may account for the needs of other nearby devices within an affiliate network, such that resources are more widely available to users in the geographic area.

As shown in block 615, the system continuously monitors a real-time location of the resource distribution vehicle. The system may monitor the real-time location of the resource distribution vehicle via a GPS device of the resource distribution vehicle. In other embodiments, the system may monitor the real-time location of the resource distribution vehicle via a GPS of a user device associated with a user travelling in the resource distribution vehicle. In some embodiments of the present invention, the user device may be an authorized device provided by the entity system or the third party entity system or one of a plurality of computing systems of the affiliate network.

As shown in block 620, the system identifies that the real-time location of the resource distribution vehicle is within a predetermined distance from one or more additional resource distribution devices in an affiliate optimization network. In this way, the system may refer to a system database or cloud database of information regarding resource distribution devices belonging to a network of affiliate institutions. In other embodiments, the system may communicate directly with a third party system which is a member of the affiliate optimization network. In either case, the system may receive information regarding the location of one or more resource distribution machines, their current status in terms of resource amounts stored at any given time, uptime or downtime of the machines, and normal traffic patterns of user activity to the one or more resource distribution machines. Using this information, the system can conduct an optimization calculation, taking into account other contextual factors such as current events, traffic patterns, or the like, and make determinations as to the best time to replenish such machines with physical resources.

Moving to block 625, the system continuously monitors one or more data streams via a quantum computing system to analyze and determine an event status. In preferred embodiments, the event status may be associated with a projected increased need for resource in the location of the resource distribution vehicle, on a route of a future resource distribution vehicle, or on a potentially accessible route by a resource distribution vehicle that does not currently service a particular geographic area or a particular resource distribution device or machine. In this way the system may take into account traffic pattern information, user device data, news data, social media data, weather data, government alert data, or the like, analyze this information in the context of one or more particular geographic areas, and via a quantum computing process, identify a projected need for additional resources in a given geographic location. As such, the system may identify resource distribution devices in that same location, and may determine a routing pattern for resource distribution vehicles to most effectively service and replenish the resource distribution devices.

As shown in block 630, the system may then, based on the event status and one or more rules of the affiliate optimization network, determine a subset of the one or more additional resource distribution devices for replenishment. For instance, once the system determines that an event may impact a particular geographic location, and determined which resource distribution devices are within the area which belong to affiliate institutions, the system may then apply a rule set determined by the affiliate network to recommend which resource distribution devices should be prioritized. In some embodiments, the rule set may be broad, in that the system has the ability to determine any or all machines within a certain area that should be prioritized. In other embodiments, the rule set may determine that certain machines should be prioritized or weighted differently in the system's analysis and determination of priority. For instance, the system may prioritize machines owned by the entity which operates the system. In other embodiments, certain affiliates may have priority over others in a tiered service level agreement. In still further embodiments, the rule set may contain extenuating circumstances wherein the rule set should be ignored, or machines should be prioritized based on determined traffic expectations and replenishment needs alone. As an example, in some embodiments, the system may determine that there is a natural disaster occurring in a certain area, and may determine that any or all machines in the location of the disaster should be prioritized for replenishment regardless of the owner, service level tier, or the like.

As shown in block 635, the system may then identify an owner for each of the subset of the one or more additional resource distribution devices and generate a network communication to the owners, employees, or certain users associated with the owners of the machines (e.g., a resource distribution vehicle operator, or the like). The system may automatically push a notification to the owner or representative that the resource distribution vehicle is in the area of the subset of the one or more resource distribution machines, and may include a message that a need has been determined for replenishment, and the need may be met by the resource distribution vehicle. Finally, as shown in block 640, the system may receive a responsive communication. The responsive communication may be an affirmative or negative communication (i.e., an acceptance or denial) of the recommendation to accept service from the nearby resource distribution vehicle. The responsive communication is then forwarded to the resource distribution vehicle by the system in order to instruct the user or operator of the resource distribution vehicle to replenish or refrain from replenishing the subset of the one or more resource distribution devices.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for resource routing using quantum optimization, the system comprising:
at least one transitory storage device; and
at least one processing device coupled to the at least one non-transitory storage device, wherein the at least one processing device is configured to:
route a resource distribution vehicle to a first resource distribution device;
continuously monitor a real-time location of the resource distribution vehicle;
identify that the real-time location of the resource distribution vehicle is within a predetermined distance from one or more additional resource distribution devices;
continuously monitor and analyze one or more data streams via a quantum computing system to determine an event status;
based on the event status, determine a subset of the one or more additional resource distribution devices which require resource replenishment;
identify an owner for each of the subset of the one or more additional resource distribution devices;
generate a network communication, wherein the communication comprises a recommendation for replenishment of resources at the subset of the one or more additional resource distribution devices and transmit the communication to the identified owners; and
receive a responsive acceptance or denial of the recommendation.

2. The system of claim 1, wherein the at least one processing device is further configured to forward the responsive acceptance or denial of the recommendation to the resource distribution vehicle.

3. The system of claim 1, wherein the event status further comprises an increased need for resource in the location of the resource distribution vehicle.

4. The system of claim 1, wherein determining a subset of the one or more additional resource distribution devices which require resource replenishment further comprises determining that the subset is owned by one or more institutions which are members of an affiliate network.

5. The system of claim 1, wherein the real-time location of the resource distribution vehicle is determined by receiving global positioning system data from the resource distribution vehicle.

6. The system of claim 1, wherein determining a subset of the one or more additional resource distribution devices which require resource replenishment further comprises applying one or more rules defined by an affiliate network.

7. The system of claim 6, wherein the one or more rules define a priority for the one or more additional resource distribution devices.

8. A computer program product for resource routing using quantum optimization, the computer program product comprising a non-transitory computer-readable storage medium having computer-executable instructions for causing a computer processor to perform the steps of:
routing a resource distribution vehicle to a first resource distribution device;
continuously monitoring a real-time location of the resource distribution vehicle;
identifying that the real-time location of the resource distribution vehicle is within a predetermined distance from one or more additional resource distribution devices;
continuously monitoring and analyze one or more data streams via a quantum computing system to determine an event status;
based on the event status, determining a subset of the one or more additional resource distribution devices which require resource replenishment;
identifying an owner for each of the subset of the one or more additional resource distribution devices;
generating a network communication, wherein the communication comprises a recommendation for replenishment of resources at the subset of the one or more additional resource distribution devices and transmit the communication to the identified owners; and
receiving a responsive acceptance or denial of the recommendation.

9. The computer program product of claim 8, wherein the at least one processing device is further configured to forward the responsive acceptance or denial of the recommendation to the resource distribution vehicle.

10. The computer program product of claim 8, wherein the event status further comprises an increased need for resource in the location of the resource distribution vehicle.

11. The computer program product of claim 8, wherein determining a subset of the one or more additional resource distribution devices which require resource replenishment further comprises determining that the subset is owned by one or more institutions which are members of an affiliate network.

12. The computer program product of claim 8, wherein the real-time location of the resource distribution vehicle is determined by receiving global positioning system data from the resource distribution vehicle.

13. The computer program product of claim 8, wherein determining a subset of the one or more additional resource distribution devices which require resource replenishment further comprises applying one or more rules defined by an affiliate network.

14. The computer program product of claim 13, wherein the one or more rules define a priority for the one or more additional resource distribution devices.

15. A computerized method for resource routing using quantum optimization, the method comprising:
routing a resource distribution vehicle to a first resource distribution device;
continuously monitoring a real-time location of the resource distribution vehicle;
identifying that the real-time location of the resource distribution vehicle is within a predetermined distance from one or more additional resource distribution devices;
continuously monitoring and analyze one or more data streams via a quantum computing system to determine an event status;
based on the event status, determining a subset of the one or more additional resource distribution devices which require resource replenishment;
identifying an owner for each of the subset of the one or more additional resource distribution devices;
generating a network communication, wherein the communication comprises a recommendation for replenishment of resources at the subset of the one or more additional resource distribution devices and transmit the communication to the identified owners; and
receiving a responsive acceptance or denial of the recommendation.

16. The computerized method of claim 15, wherein the at least one processing device is further configured to forward the responsive acceptance or denial of the recommendation to the resource distribution vehicle.

17. The computerized method of claim 15, wherein the event status further comprises an increased need for resource in the location of the resource distribution vehicle.

18. The computerized method of claim 15, wherein determining a subset of the one or more additional resource distribution devices which require resource replenishment further comprises determining that the subset is owned by one or more institutions which are members of an affiliate network.

19. The computerized method of claim 15, wherein the real-time location of the resource distribution vehicle is determined by receiving global positioning system data from the resource distribution vehicle.

20. The computerized method of claim 15, wherein determining a subset of the one or more additional resource distribution devices which require resource replenishment further comprises applying one or more rules defined by an affiliate network.
